(19) United States
(12) Patent Application Publication
(10) Pub. No.: US 2004/0111626 A1
(43) Pub. Date: Jun. 10, 2004

(54) Security processing of unlimited data size

(76) Inventor: Doron Livny, Ein Ayala (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/314,277

(22) Filed: Dec. 9, 2002

(51) Int. Cl. G06F 12/14

(52) U.S. Cl. 713/189

(57) ABSTRACT

A hardware security block system and method including a security processor unit to perform a security process on a data chunk of at most a predefined size and a memory access unit to transfer the data chunk of at most the predefined size to the security processor unit from an unlimited size data segment in an upper layer. A method and system including receiving a partial data chunk and associated control information, where the partial data chunk is a portion of an unlimited size data segment in an upper layer, determining a security value, and security processing the partial data chunk.

### BACKGROUND OF THE INVENTION

Security of information is a major concern. Software algorithms to encrypt, decrypt, and authenticate information stored on a medium or sent over a communication channel are well known in the art. However, such software algorithms generally provide results at a slow rate compared to the rates at which data may be transferred either internally or over a network.

Thus, acceleration hardware may be necessary to perform the encryption, decryption, and authentication functions. However, acceleration hardware requires large amounts of logic circuitry. Furthermore, the size and complexity of the logic design is generally related to the size of the block of information to be handled by the accelerators.

Therefore, implementations of security acceleration known in the art generally impose predetermined hardware design limits to both the size and complexity of the information blocks to be handled.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings, in which:

FIG. 1 is a block diagram illustration of a hardware security block, in accordance with an embodiment of the present invention;

FIGS. 2A and 2B are block diagram illustrations of security processing of data of unlimited size, in accordance with an embodiment of the present invention;

FIGS. 3A and 3B are figurative illustrations depicting the processing of the encryption and decryption hardware, respectively, of the security processing unit of FIG. 1, in accordance with an embodiment of the present invention;

FIG. 4 is a flow chart diagram of a method for encrypting/authenticating data of unlimited size, in accordance with an embodiment of the present invention;

FIG. 5 is a block diagram illustration of data flow in a device, in accordance with an embodiment of the present invention; and

FIG. 6 is a sequence diagram illustration of data flow in the network card of FIG. 5, in accordance with an embodiment of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, and components have not been described in detail so as not to obscure the present invention.

Unless specifically stated otherwise, as apparent from the following discussions, it is appreciated that, throughout the specification, discussions utilizing terms such as “processing,” “computing,” “calculating,” “determniing,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the description hereinbelow, the term “upper layers” refers to processes and hardware operatively connected to the hardware security block of embodiments of the present invention. Upper layers may include, for example, an Ethernet controller, an operating system, a procedure, a software process, data memory, a process using the Internet protocol version 6 (IPv6) standard, and a process using the Internet protocol version 4 (IPv4) standard.

In the description hereinbelow, the term “security process” may refer to any process describing a security operation, for example, encryption, decryption, and authentication. Likewise, the term “security processing” may refer to performing security operations, for example, encryption, decryption, and authentication.

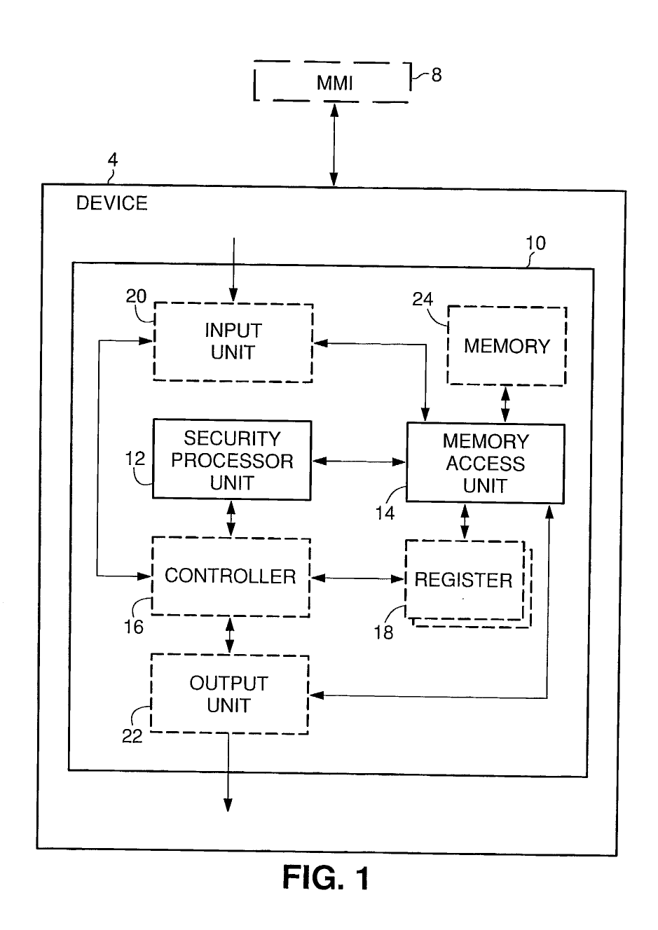

Reference is now made to FIG. 1, a block diagram illustration of a device 4 which may be operatively connected to an optional man-machine interface 8. Man-machine interface 8 may be internal or external to device 4. Exemplary man-machine interfaces 8 include a keyboard, a screen, a mouse, a roller-ball, a speaker, a microphone, and a camera.

Although the scope of the present invention is not limited in this respect, device 4 may be, for example, a computer device, a personal digital assistant (PDA), a telephone, an embedded system, or any other system comprising data that may be secured by encryption/authentication means. Exemplary computer devices may include portable, desktop, and mainframe computing devices, for example, a laptop computer, a notebook computer, a personal computer, and a mobile computer. A telephone may be, for example, a landline or mobile telephone.

Although the scope of the present invention is not limited in this respect, the following are exemplary uses of the present invention in a telephone. A user may speak into a telephone microphone and the speech may be converted to analog or digital data. In an embodiment of the present invention, it may be possible to encrypt/authenticate the data before transmission, which may increase security and privacy. In a further example, there exist telephones that comprise a camera, which may allow a user to take a picture and send it to another user. It may be possible, in an embodiment of the present invention, to encrypt the picture before sending.

Although the scope of the present invention is not limited in this respect the following are exemplary uses of the present invention in a computer device. An embodiment of the present invention may be used in a network card to secure data that is transmitted over a network. In another exemplary embodiment, the present invention may be embedded on a computer device to secure data, for example files, which may be stored on the computer device. Similar exemplary uses are possible on other devices comprising data to be secured.

Hardware security block 10 may comprise a security processor unit 12, a memory access unit 14, an optional controller 16, optional memory registers 18, an optional input unit 20, an optional output unit 22, and optional memory 24. It is noted that optional memory registers 18 and optional memory 24 may be physical entities whose size and number are fixed.

Data to undergo security processing and the control data associated therewith, may come from any source, for example from the memory of the computer device in which security block 10 is located or from a remote device. Memory access unit 14 may retrieve the data for security processing via input unit 20 and may output the processed data via output unit 22. Memory access unit 14 may further use memory 24 and register 18 for temporary local data storage. In an exemplary embodiment, register 18 may store control information and/or commands that may be necessary for the security processing and memory 24 may store intermediate processing results. It is noted that register 18 and memory 24 may be used interchangeably in embodiments of the present invention. Hereinbelow, the term local data storage may refer to register 18 and/or memory 24. Controller 16 may manage elements of security block 10 such as input unit 20, security processor unit 12, output unit 22, and registers 18. Security processor unit 12 may receive the data from memory access unit 14 and may security process the data as described hereinbelow.

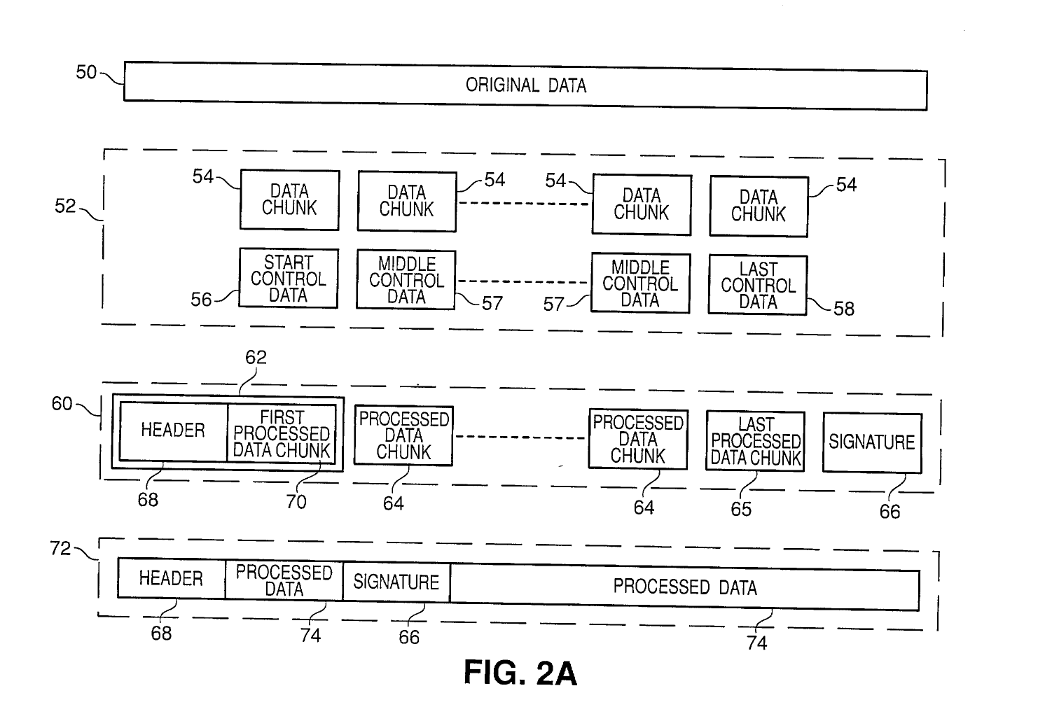

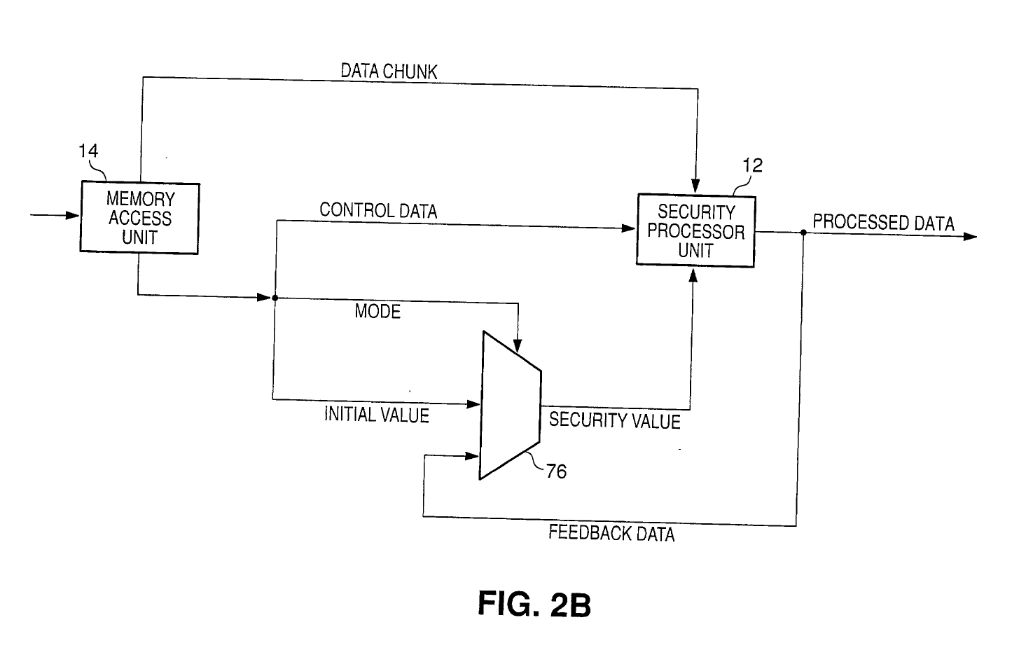

Reference is now made to FIG. 2A, a block diagram illustration of security processing of data of unlimited size in accordance with an embodiment of the present invention. The original data, an unlimited size data segement, (labeled 50) may be of any size, for example 64 kilobytes (K). All sizes given are for exemplary purposes only, to assist in the clarity of the description, and do not limit the scope of the invention.

This data may be divided by a driver and/or other upper layer process into data chunks 54 of a predetermined size, for example 1.5K. The size may be selected to correspond to the type of processing for which the hardware may be used; for example, 1.5K may be appropriate for Ethernet processing. The driver and/or other upper layer process may also send a command block to security block 10 (FIG. 1), which may comprise, for example, the security process to perform, the algorithm to use, and various control information.

In many applications and protocols, the beginning and end of processing may require special handling or the receipt of special information. Thus, control information may vary for different sections of the data and may, therefore, include a mode that may have differing possible values, for example, “start”, “middle”, and “last”. These values may indicate which section of data corresponds to the particular control information. Other control information may include keys and the total data size.

Data may be processed one chunk at a time. Memory access unit 14 (FIG. 1) may retrieve a data chunk 54. Specific control information may be associated with this data chunk 54, for example, start control data 56, middle control data 57, or last control data 58. Together, the set of data chunks 54 and control data 56, 57, and 58 figuratively represent the set of intermediate data 52 as it may be processed by security block 10.

Start control data 56 may, for example, comprise the mode value “start”, an initial encryption/decryption value, and an authorization initial key value. Middle control data 57 may, for example, comprise only the mode value “middle”. Last control data 58 may, for example, comprise the mode value “last”, a final authentication key, and a message size.

In an embodiment of the present invention, it may not be necessary to receive all the data to begin security processing. Hence, each data chunk 54 may be processed as it is received by security block 10. The first processed block of data, processed chunk 62, may comprise two sections, a header 68 and a first processed data chunk 70. It is noted that header 68 may not be related specifically to first processed data chunk 70, but rather may comprise information relating to the data as a whole, for example, the security algorithm used.

As security processing continues, processed data chunks 64 may be created. As each piece of processed data is created (processed chunk 62 and processed data chunks 64), it may be sent to the upper layers. It may not be necessary to wait until all the original data has been processed. After last processed data chunk 65 has been created, a signature 66 may be generated and sent to the upper layers. Last data chunk 65 may further require padding for data alignment.

Thus at the end of the security process, the upper layers may have received a set of processed data (labeled 60), which comprises processed chunk 62, processed data chunks 64, and last data chunk 65 in the order in which they were processed. The upper layers may concatenate the pieces of processed data 60 and may place signature 66 at the correct position within a processed data block 72. First processed data chunk 70, any processed data chunks 64, and last processed data chunk 65 may when concatenated be referred to as processed data 74. This processed data 74 may be divided into two sections by signature 66. The position of signature 66 may vary depending on the requirements of the protocol or application being used. Hence, when complete, processed data block 72 may comprise a single data block comprising header 68, a first processed data 74, signature 66, and a second processed data 74. When the security process is encryption, processed data 74 may be encrypted data. When the security process is decryption, processed data 74 may be decrypted data. It is noted that the first process data 74 and the second processed data 74, may not be the same size.

When the security process is authentication, only signature 66 may be sent to the upper layers. Though the security processing method may be similar to the description hereinabove, the other portions of processed data 60 may not be saved outside the temporary local storage of security block 10 (FIG. 1).

FIG. 2B, to which reference is now made, is a further block diagram illustration of security processing of data of unlimited size, in accordance with an embodiment of the present invention.

As explained hereinabove, in security processing, chunks of data may be retrieved by memory access unit 14. For each chunk there may be two types of information, control data and a chunk of data. Control data may comprise any of start control data, middle control data, or last control data (56, 57, or 58 of FIG. 2A). Control data and a chunk of data may be input to security processor unit 12. Security processing may be performed on the chunk of data, including any special processing required as indicated by the control data.

When security processing on a chunk is complete, security processor unit 12 may generate processed data (element 60 of FIG. 2A) as output and feedback data. The processed data may comprise any of a processed chunk, processed data chunk, last processed data chunk, and signature (elements 62, 64, 65, and 66 of FIG. 2A). As described hereinabove, the exact output in the processed data may vary depending on the security process performed. It is noted that the processed data may further be used as feedback data.

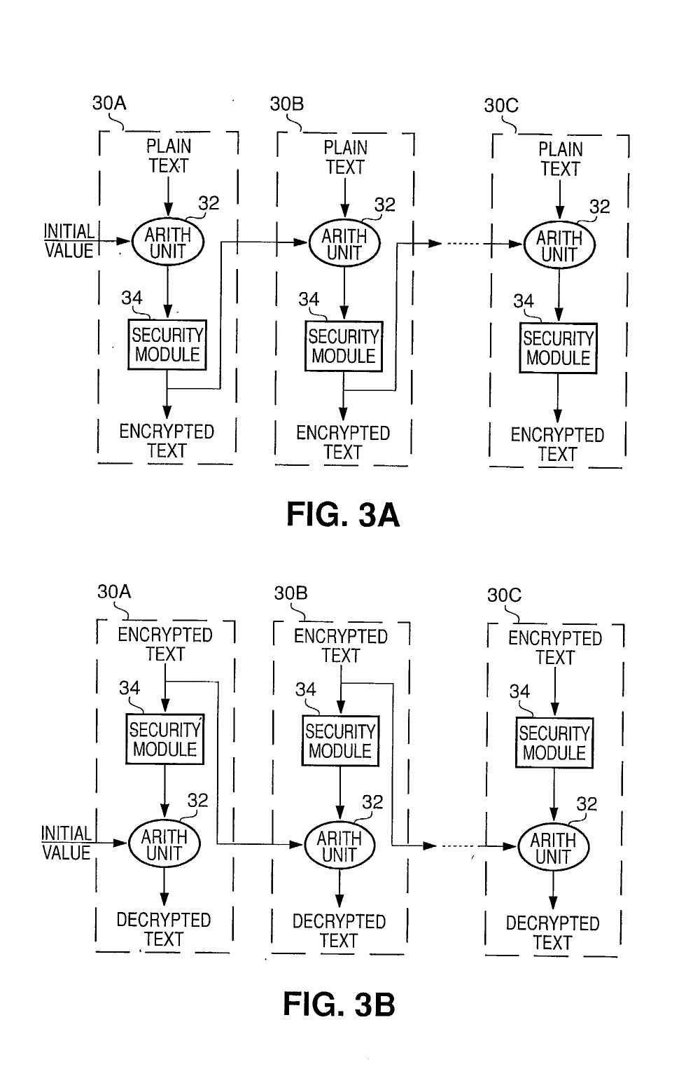

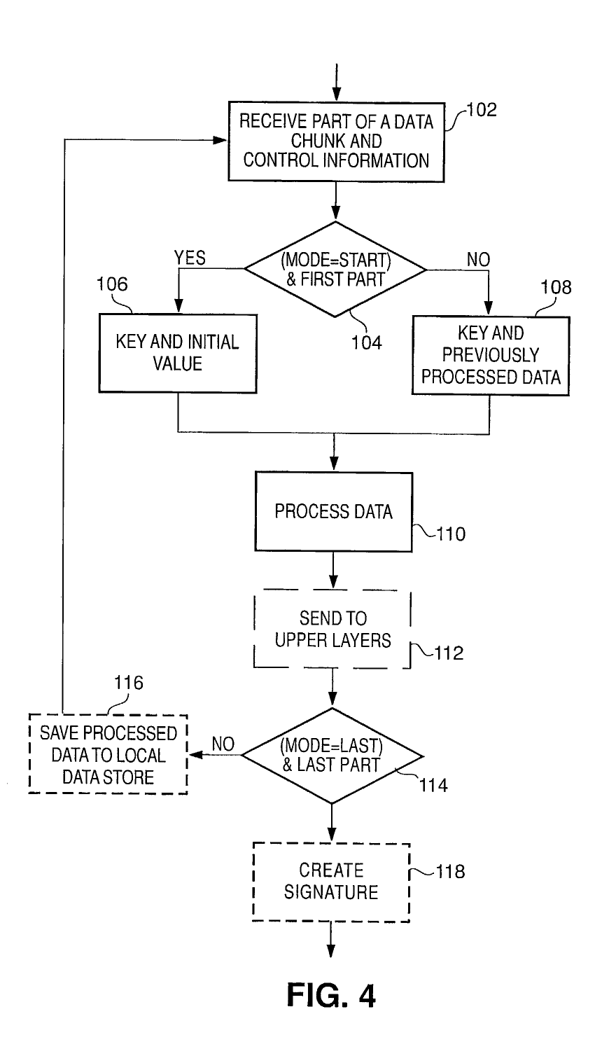

Feedback data, an initial value, and the mode may be input to multiplexer 76. As will be described in detail hereinbelow with respect to FIGS. 3A, 3B, and 4, multiplexer (MUX) 76 may input a value, hereinbelow referred to as a “security value”, to security processor unit 12. Security processing may continue with receipt from memory access unit 14 of the next data chunk and control data, and the security value from MUX 76 by security processor 12. Processing may continue until the last data chunk has been processed.

FIGS. 3A and 3B, to which reference is now made, are figurative illustrations of an exemplary logic circuit 30 which may be used by security processor unit 12, in a security process, in accordance with an embodiment of the present invention. FIG. 3A illustrates an encryption logic circuit 30, whereas FIG. 33B illustrates a decryption logic circuit 30. The same physical hardware elements may be used, although the data flow within logic circuit 30 may be different for different security processes. Furthermore, though the illustration shows multiple logic circuits 30, this is only for the clarity of the description. In an embodiment of the present invention, there may be one logic circuit 30, which may be used repeatedly during an encryption, decryption, or authentication process. In fact the number of logic circuits 30 is an implementation detail and is not relevant to the present invention.

It is also noted that a particular logic circuit 30 may comprise multiple engines wherein each engine may perform a different security algorithm. Although the scope of the present invention is not limited in this respect, in the following description the example of text data with a specific engine is used.

Due to physical limits, only a predetermined amount of data from a given data chunk 54 may be input at one time to logic circuit 30. In an exemplary embodiment using the data encryption standard (DES), data chunk 54 may comprise 1.5 K and logic circuit 30 may process 64 bit “partial chunks” of text. In a further embodiment using the advanced encryption standard (AES) algorithm, logic circuit 30 may process 128 bit “partial chunks”. The particular embodiment described herein may be appropriate for cipher block chaining (CBC) processing with either the DES or AES algorithm.

In FIGS. 3A and 3B, logic circuits 30 may be used as follows. Logic circuit 30A may be used in processing the first data chunk wherein the associated mode equals “start”. Logic circuit 30B may be used in processing the intermediate data chunks wherein the associated mode equals “middle”. Finally, logic circuit 30C may be used in processing the final data chunk wherein the associated mode equals “last”. However, this representation is figurative only and is used to further point out the differences in data flow and inputs depending on the position of the data chunk within the original data. If there was only one data chunk being processed, for example, logic circuit 30A, B, and C would all be folded together using the special inputs of logic circuit 30A and the output flow corresponding to logic circuit 30C.

In the exemplary embodiment shown in FIG. 3A, figurative encryption logic circuit 30 may comprise an arithmetic/logic unit 32 and a security module 34. Arithmetic/logic unit 32 may be wired to perform a predetermined number of arithmetic/logic operations, for example, an “exclusive or” (XOR). Security module 34 may execute an encryption-decryption/authentication algorithm. Any appropriate security algorithm known in the art may be used, for example, AES, secure hashing algorithm 1 (SHA-1), message digest 5 (MD5), DES, or triple data encryption standard (3DES).

When processing begins, figurative encryption logic circuit 30A may receive a predetermined initial value, for example as part of the control data, which may be used as the security value. The control data may supply any input values that may be required by the particular security process being used. These requirements may be defined by the security algorithm, and their particulars may not be relevant to the present invention. A partial chunk of plain text data may also be input to arithmetic/logic unit 32. An arithmetic/logical operation may be applied to the two input values. The result may be input to security module 34, which may perform a security algorithm for encryption/authentication and may output encrypted data.

After the first plain text partial chunk has been processed, figurative encryption logic circuits 30B and 30C may not use a value input with the control data. Instead, in an embodiment of the present invention, the previous encrypted data chunk may be used as the security value. Thus, the previous encrypted data and the next partial chunk of plain text data may be input to arithmetic/logic unit 32 of circuit 30B or 30C. An arithmetic/logical operation may be applied to the two input values. The result may be input to security module 34 which may perform the security algorithm and may output encrypted text.

When the last plain text partial chunk has been processed, encryption logic circuit 30C may not reuse the encrypted data chunk. Processing may terminate with output of encrypted text and a signature (not shown).

Authentication may use a different security algorithm wherein the resultant processed data may not be kept. Each partial chunk may be processed in a manner similar to that described for encryption, but the processed result may not be sent to the upper layers. The encrypted partial data chunk may only be used, as the security value for the next partial data chunk and no encrypted text may be output. When all the data has been processed, the security block may return only a signature and/or an output value (not shown) that may indicate whether the data has been authenticated.

It is noted that in an embodiment of the present invention, authentication and encryption/decryption may be processed in parallel. For example, if the same algorithm is being used for both authentication and encryption, results for both processes may be sent to the upper layers as appropriate.

In the exemplary embodiment shown in FIG. 3B, figurative decryption logic circuit 30 may comprise a security module 34 and an arithmetic/logic unit 32. Security module 34 may execute an encryption-decryption/authentication algorithm. Any appropriate security algorithm known in the art may be used, for example, the algorithms mentioned hereinabove. Arithmetic/logic unit 32 may be wired to perform a predetermined number of arithmetic/logic operations, for example, an “exclusive or” (XOR). It is noted that the same algorithm and arithmetic/logic operation used to encrypt the data may generally be used to decrypt it.

When processing begins, figurative decryption logic circuit 30A may receive a partial chunk of encrypted text data. This partial chunk may be saved temporarily for use in arithmetic/logic unit 32 of decryption logic circuit 30B (or 30C if appropriate) as the security value. This partial chunk may also be input to security module 34 (of circuit 30A), a decryption algorithm may be performed, and the output may be input to arithmetic/logic unit 32 (of circuit 30A). A predetermined initial value may also be input to arithmetic/logic unit 32, for example from the control data. The initial value may be used as the security value. An arithmetic/logical operation may be applied to the two input values and the result may be output as decrypted text.

Processing may continue in logic circuit 30B with the next partial chunk of encrypted text data being received by security module 34. After the first encrypted text partial chunk has been processed, decryption logic circuits 30B and 30C may not use a value input with the control data. Instead, in an embodiment of the present invention, the previously input encrypted text, which may have been saved, may be used as the security value. Thus, the previous partial chunk of encrypted text and the output of security module 34 on the present partial chunk of encrypted text data may be input to arithmetic/logic unit 32. An arithmetic/logical operation may be applied to the two input values and the result may be output as decrypted text. Additionally, the present partial chunk of encrypted text data may have been saved temporarily, as described above.

When the last encrypted text partial chunk has been processed, decryption logic circuit 30C may not save the encrypted data chunk. Processing may terminate with output of decrypted text only.

FIG. 4, to which reference is now made, is a flow chart diagram of a method for encrypting/authenticating data of unlimited size, in accordance with an embodiment of the present invention. Control information and data may have been received by security processor unit 12 (FIG. 1) (step 102). The control information may include for example a key value. The data may be a part of a data chunk, which has been received by security block 10 (FIG. 1) from a host or upper layer.

The mode control information may be checked (step 104). If the mode is “start” and the data is the first part of the data in the chunk, the initial value, which may have been received with the control information, may be used as the security value. This may be used with any other control information, which was received (step 106). In the example used hereinabove with respect to FIGS. 3A and 3B, the data must be from the first 64 bits of the first chunk of data from the original data. If both of these conditions are not true, the previously processed data chunk may be used as the security value and the rest of the control information, excluding the initial value, may be used (step 108).

The data may then be processed (step 110). Processing may comprise performing an arithmetic/logical operation between a security value and the data and execution of a security algorithm.

The resultant processed data may be written to the upper layers (step 112). In some cases the data chunk may not be written, for example in the case of authentication. If the mode is “last” and it is the last part of data in the chunk (step 114) then a signature may be created and sent to the upper layers (step 118). If not, the processed data chunk may be saved to a local data storage for use as a security value (step 116), and data processing may continue (returning to step 102).

A method of decryption of data of unlimited size, in accordance with an embodiment of the present invention, may be similar to that shown in FIG. 4. A difference may be that of the processed data chunk may not be saved at step 116. Instead the incoming partial data chunk may be saved to a local data store before it is process, for example after step 102 or before step 110.

An embodiment of the present invention may be used, for example, in IPv6 compliant processing. The IPv6 standard requires that all the data be processed as a whole and a single signature written for all the data. This is different from the IPv4 standard, in which data is processed in fragments/chunks and each chunk is given a separate signature.

An embodiment of the present invention may also be used to securely store data on a computer. For example, whole files may be automatically encrypted when stored and decrypted when opened. This may be done for any type of file, for example, a text document.

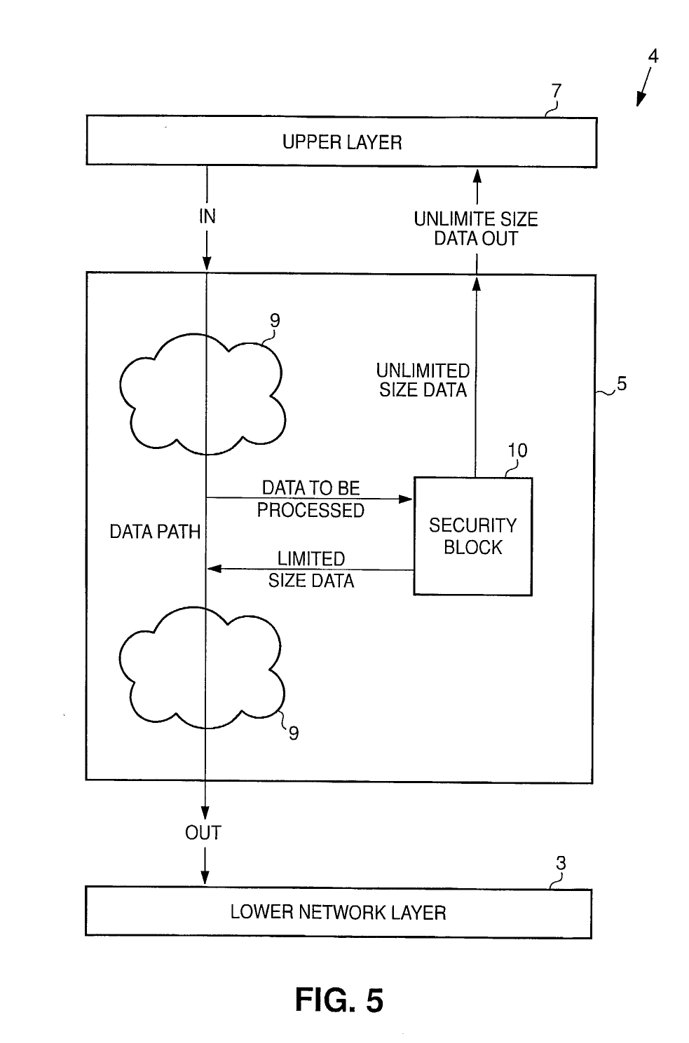

Reference is now made to FIG. 5, a block diagram illustration of data flow in device 4, in accordance with an embodiment of the present invention. Although the scope of the present invention is not limited in this respect, device 4 may be a computer device comprising a network card 5 in which data may flow into and out of, to and from, at least one upper layer 7 (as defined hereinabove).

Data may flow from upper layer 7 into network card 5 along a data path (arrow). Some processing may occur along the way, as represented by clouds 9. Regular data, which does not require security processing, may flow along arrow “data path” and may be transmitted by network card 5 to lower networking layers 3, without being sent to security block 10. Data requiring security processing may flow along arrow “data to be processed” to security block 10.

In the case of limited size data, processing may be completed by security block 10 and the processed data may be returned along arrow “limited size data” to arrow “data path”. This processed data may follow arrow “data path” and may be transmitted by network card 5 to lower networking layers 3. In the case of a chunk of unlimited size data, after processing by security block 10 the chunk of unlimited size processed data may be sent along arrow “unlimited size data” to an upper layer 7. It may not be transmitted by network card 5 directly to lower networking layers 3, as it may need to be concatenated with other chunks of the unlimited size data under the control of upper layer 7.

It is noted that the unlimited size data may not be transmitted at all. In an exemplary use of the present invention, the data may be a data file stored locally, in a secure mode. Furthermore, the security block may not be in a network card, but rather in any suitable part of any suitable device.

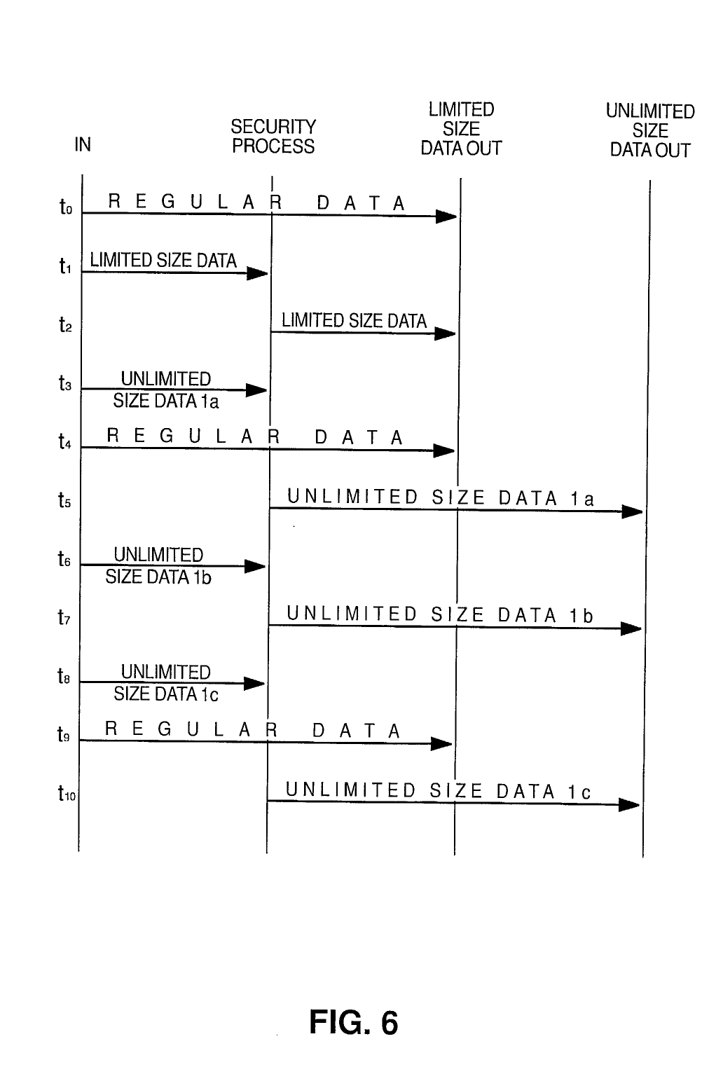

FIG. 6, to which reference is now made, is a sequence diagram illustration of data flow in network card 5 (of FIG. 5), in accordance with an embodiment of the present invention. The particular order of data receipt shown (i.e. regular data, limited size data, unlimited size data 1a, etc.) is for exemplary purposes only and the scope of the present invention is not limited in this respect.

Data may be received by a network card (time to). In the case of regular data, it may flow along the main data path the network card and may be transmitted out. The regular data may not be sent to any security process. Next a block of limited size data requiring security processing may be received (time t₁). It may “detour” from the main data path to a security process. When security processing is complete (time t₂), it may return to the main data path and may be transmitted by the network card. No other data may be processed until the limited size data may have been returned to the main data path.

A first chunk of an unlimited size data block (denoted unlimited size data 1a) may be received by the network card for security processing (time t₃). It may be sent from the main data path to a security process. While processing may continue, a block of regular data may be received by the network card (time t₄). It may flow directly along the main data path and be transmitted by the network card. When security processing on unlimited size data 1a is complete (time t₅) it may be sent back to the upper layers along the unlimited size data out path. Only when processing of the first chunk of the unlimited size data block is complete may a next chunk of the unlimited size data block, unlimited size data 1b, be received (time t₆). This second chunk may be processed and may then be sent back to the upper layer (time t₇).

A third chunk of unlimited size data 1c may be received (time t₈). While it is processing, another block of regular data may be received (time t₉) and transmitted by the network card. Upon completion of processing, unlimited size data 1c may be sent to the upper layer (time t₁₀).

Thus it may be seen that, in an embodiment of the present invention, while a chunk of data from an unlimited size data block is being security processed, regular data, which does not require security processing, may continue to be transmitted along its normal data path.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A hardware security block comprising:
a security processor unit to perform a security process on a data chunk of at most a predefined size; and
a memory access unit to transfer the data chunk of at most the predefined size to said security processor unit from an unlimited size data segment in an upper layer.

2. The hardware security block of claim 1 wherein the security process is selected from the group consisting of encryption, decryption, and authentication.

3. The hardware security block of claim 2 further comprising a local data storage to store an output of said security processor unit, wherein the content of said local data storage is input to said security processor unit.

4. The hardware security block of claim 3 wherein said security processor unit is able to receive control information comprising a mode value to indicate the position of the data chunk of at most the predefined size within the unlimited sized data segment.

5. A system comprising:
a portable computer comprising:
a man-machine interface unit;
a security processor unit to perform a security process on a data chunk of at most a predefined size; and
a memory access unit to transfer the data chunk of at most the predefined size to said security processor unit from an unlimited size data segment in an upper layer.

6. The system of claim 5 wherein the security process is selected from the group consisting of encryption, decryption, and authentication.

7. The system of claim 5 further comprising a local data storage to store an output of said security processor unit, wherein the content of said local data storage is input to said security processor unit.

8. The system of claim 5 wherein said security processor unit is able to receive control information comprising a mode value to indicate the position of the data chunk of at most the predefined size within the unlimited sized data segment.

9. A method comprising:
receiving a partial data chunk and control information associated therewith, wherein the partial data chunk is a portion of an unlimited size data segment in an upper layer;
determining a security value; and
security processing the partial data chunk.

10. The method of claim 9 further comprising saving a security processing output in a local data store.

11. The method of claim 9 further comprising sending a security processing output to the upper layer.

12. The method of claim 9 further comprising creating a signature.

13. A hardware security method comprising:
receiving a data chunk of at most a predefined size from an unlimited size data segment in an upper layer; and
security processing in hardware the data chunk of at most a predefined size.

14. The method of claim 13 wherein the security processing is selected from the group consisting of encrypting, decrypting, and authenticating.

15. The method of claim 13 further comprising storing in a local data store an intermediate security process result for use in a next security processing.

16. The method of claim 13 further comprising receiving control information comprising a mode value to indicate the position of the data chunk of at most the predefined size within the unlimited sized data segment.
